(19) United States
(12) Patent Application Publication
(10) Pub. No.: US 2011/0129676 A1
(43) Pub. Date: Jun. 2, 2011

(54) MULTI-LAYERED FRONT SHEET ENCAPSULANT FOR PHOTOVOLTAIC MODULES

(76) Inventors: David J. Bravet, Westborough, MA (US); Maryann C. Kenney, Foxboro, MA (US)

(21) Appl. No.: 12/628,369

(22) Filed: Dec. 1, 2009

(51) Int. Cl. B32B 27/38; B32B 9/00; B32B 27/30; B32B 27/00

(52) U.S. Cl. 428/413; 428/447; 428/422; 428/421

(57) ABSTRACT

The invention describes a multi-layered film comprising a modified fluoropolymer and a silicone material. The laminate is useful to protect a photovoltaic cell, for example, as an encapsulant.

### CROSS REFERENCE TO RELATED APPLICATIONS

None

### FIELD OF THE INVENTION

The invention relates generally to multilayer fluoropolymer/silicone films or laminates, and methods for their manufacture that are useful as packaging materials.

### BACKGROUND OF THE INVENTION

Multilayer films or laminates are constructions, which attempt to incorporate the properties of dissimilar materials in order to provide an improved performance versus the materials separately. Such properties include barrier resistance to elements such as water, cut-through resistance, weathering resistance and/or electrical insulation. Up until the present invention, such laminates often result in a mis-balance of properties, are expensive, or difficult to handle or process. In addition, the inner layers are often not fully protected over the life of the laminate.

Sophisticated equipment in the electrical and electronic fields requires that the components of the various pieces of equipment be protected from the effects of moisture and the like. For example, photovoltaic cells and solar panels comprising photovoltaic cells must be protected from the elements, especially moisture, which can negatively impact the function of the cells. In addition, circuit boards used in relatively complicated pieces of equipment such as computers, televisions, radios, telephones, and other electronic devices should be protected from the effects of moisture. In the past, solutions to the problem of moisture utilized metal foils as a vapor or moisture barrier. Metal foils, however, must be insulated from the electronic component to avoid interfering with performance. Previous laminates using metal foils typically displayed a lower level of dielectric strength than was desirable, while other laminates using a metal foil layer were also susceptible to other environmental conditions.

Thin multi-layer films are useful in many applications, particularly where the properties of one layer of the multi-layer film complement the properties of another layer, providing the multi-layer film with properties or qualities that cannot be obtained in a single layer film. Previous multi-layer films provided only one of the two qualities desirable for multi-layer films for use in electronic devices.

A need remains for a multi-layer film that provides an effective barrier to moisture while also providing high dielectric strength or low dielectric constant, and mechanical flexibility.

### BRIEF SUMMARY OF THE INVENTION

The present invention surprisingly provides multi-layer films, and processes to prepare such films, that overcome one or more of the disadvantages known in the art. It has been discovered that it is possible to make and use multi-layer films having characteristics, for example, suitable for packaging materials for electronic devices. These films help to protect the components from environmental exposure such as from heat, humidity, chemicals, or solar radiation; or from physical damage and general wear and tear. Such packaging materials help to electrically insulate the active components/circuits of the electronic devices.

In one aspect, the present invention provides a fluoropolymer multi-layer film that includes a first substrate that can be a modified fluoropolymer having polar functionality and a second silicone substrate. Generally, the substrates are coprocessed under suitable conditions to effect adhesion between the two layers to form the multi-layer film. Elevated temperatures and or pressures can be utilized to help adhere the two or more layers to each other. Suitable processes include coextrusion, extrusion coating, extrusion lamination and lamination.

In the various embodiments of the laminates, typical modified fluoropolymers include PVDF, VDF copolymers, THV, HTE, ECTFE and ETFE. In one particular aspect, the fluoropolymer is modified by treatment prior to lamination by either corona discharge (plasma) or by subjection to an electron beam curtain. In particular, the pretreatment can be in the presence of an organic solvent, such as acetone.

The second substrate can be any silicone material that has functionality suitable to interact with the modified fluoropolymer under the conditions described herein. Such materials include, silicone-based thermoplastic elastomers such as those marketed under the tradename Geniomer® available from Wacker Chemie. Suitable silicone thermoplastics include those such as the Geniomer's which are silicone copolymers containing over 90% siloxane. Geniomer® is a two phase block copolymer made up of a soft polydimethylsiloxane (PDSM) phase and a hard aliphatic isocyanate phase.

While multiple embodiments are disclosed, still other embodiments of the present invention will become apparent to those skilled in the art from the following detailed description. As will be apparent, the invention is capable of modifications in various obvious aspects, all without departing from the spirit and scope of the present invention. Accordingly, the detailed descriptions are to be regarded as illustrative in nature and not restrictive.

### DETAILED DESCRIPTION

In the specification and in the claims, the terms “including” and “comprising” are open-ended terms and should be interpreted to mean “including, but not limited to . . . ” These terms encompass the more restrictive terms “consisting essentially of” and “consisting of.”

It must be noted that as used herein and in the appended claims, the singular forms “a”, “an”, and “the” include plural reference unless the context clearly dictates otherwise. As well, the terms “a” (or “an”), “one or more” and “at least one” can be used interchangeably herein. It is also to be noted that the terms “comprising”, “including”, “characterized by” and “having” can be used interchangeably.

Unless defined otherwise, all technical and scientific terms used herein have the same meanings as commonly understood by one of ordinary skill in the art to which this invention belongs. All publications and patents specifically mentioned herein are incorporated by reference in their entirety for all purposes including describing and disclosing the chemicals, instruments, statistical analyses and methodologies which are reported in the publications which might be used in connection with the invention. All references cited in this specification are to be taken as indicative of the level of skill in the art. Nothing herein is to be construed as an admission that the invention is not entitled to antedate such disclosure by virtue of prior invention.

Photovoltaic modules contain an active element that converts sunlight to electricity, various electrical connections, and packaging layers to seal and protect the active element from damage during handling and installation, as well as to protect it from environmental effects during the course of its lifetime. A variety of methods and materials have been used to accomplish this packaging and protection. Oftentimes multiple layer constructions will be used to cushion and protect the active element. The most common material used as a cushioning layer, or encapsulant, is ethylene vinyl acetate (EVA). The EVA normally contains a high vinyl acetate content (>30%) and must be crosslinked to obtain the necessary mechanical properties. This is accomplished with peroxides and requires use of a vacuum laminator. EVA has been widely used in combination with a variety of front surfaces. For example, typical crystalline silicon modules use EVA with an outer layer of glass. Flexible amorphous silicon modules use EVA with an outer flexible layer of fluoropolymer film such as ETFE (ethylene tetrafluoroethylene). To form an effective front sheet encapsulant combination with EVA and ETFE commonly requires a multi-step process in which the ETFE film is extruded and surface treated for improved adhesion. EVA is then extrusion coated on to the surface in a second step. The process must be carefully controlled so as not to react prematurely the peroxide crosslinker. The combined sheet is then laminated to the active photovoltaic element in a vacuum laminator.

The present invention provides a coprocessed front sheet encapsulant laminate that combines a modified fluoropolymer protective outer surface and a thermoplastic silicone encapsulant film into a single structure. The laminate can be easily handled and processed, and does not require vacuum to cure. Because this construction uses a non curable thermoplastic material, the material could readily be used in a non vacuum faster production method with shorter lamination cycle like roll-to-roll production, which is considered more economical. Of course the co-processed front sheet encapsulant laminate can be used with state-of-the-art vacuum lamination methods used in the industry. In this case, the lamination cycles are also expected to be shorter.

The fluoropolymer materials appropriate for the photovoltaic cell front sheet are selected from the family of fluorinated polymers, such as tetrafluoroethylene copolymers.

The phrase “fluoropolymer” is known in the art and is intended to include, for example, polytetrafluoroethylene, copolymers of tetrafluoroethylene and hexafluoropropylene, tetrafluoroethylene-perfluoro(alkyl vinyl ether) copolymers (e.g., tetrafluoroethylene-perfluoro(propyl vinyl ether), FEP (fluorinated ethylene propylene copolymers), polyvinyl fluoride, polyvinylidene fluoride, and copolymers of vinyl fluoride, chlorotrifluoroethylene, and/or vinylidene difluoride (i.e., VDF) with one or more ethylenically unsaturated monomers such as alkenes (e.g., ethylene, propylene, butylene, and 1-octene), chloroalkenes (e.g., vinyl chloride and tetrachloroethylene), chlorofluoroalkenes (e.g., chlorotrifluoroethylene), fluoroalkenes (e.g., trifluoroethylene, tetrafluoroethylene (i.e., TFE), 1-hydropentafluoropropene, 2-hydropentafluoropropene, hexafluoropropylene (i.e. HFP), and vinyl fluoride), perfluoroalkoxyalkyl vinyl ethers (e.g., CF₃OCF₂CF₂CF₂OCF═CF₂); perfluoroalkyl vinyl ethers (e.g., CF₃OCF═CF₂ and CF₃C₂CF₂OCF═CF₂), and combinations thereof.

The fluoropolymer can be melt-processable, for example, as in the case of polyvinylidene fluoride; copolymers of vinylidene fluoride; copolymers of tetrafluoroethylene, hexafluoropropylene, and vinylidene fluoride copolymers of tetrafluoroethylene and hexafluoropropylene; copolymers of ethylene and tetrafluoroethylene and other melt-processable fluoroplastics; or the fluoropolymer may not be melt-processable, for example, as in the case of polytetrafluoroethylene, copolymers of TFE and low levels of fluorinated vinyl ethers, and cured fluoroelastomers.

Useful fluoropolymers include copolymers of HFP, TFE, and VDF (i.e., THV). Examples of THV polymers include those marketed by Dyneon, LLC under the trade designations “DYNEON THV.

Additional commercially available vinylidene fluoride-containing fluoropolymers include, for example, those fluoropolymers having the trade designations; “KYNAR” (e.g., “KYNAR 740”) as marketed by Arkema, Philadelphia, Pa.; “HYLAR” (e.g., “HYLAR 700”) and “SOLEF” as marketed by Solvay Solexis USA, West Deptford, N.J.; and “DYNEON PVDF Fluoroplastics” such as DYNEON FP 109/0001 as marketed by Dyneon, LLC; Copolymers of vinylidene difluoride and hexafluoropropylene are also useful. These include for example KYNARFLEX (e.g. KYNARFLEX 2800 or KYNARFLEX 2550) as marketed by Arkema.

Commercially available vinyl fluoride fluoropolymers include, for example, those homopolymers of vinyl fluoride marketed under the trade designation “TEDLAR” by E.I. du Pont de Nemours & Company, Wilmington, Del.

Useful fluoropolymers also include copolymers of tetrafluoroethylene and propylene (TFE/P). Such polymers are commercially available, for example, under the trade designations “AFLAS” as marketed by AGC Chemicals America, or “VITON” as marketed by E.I. du Pont de Nemours & Company, Wilmington, Del.

Useful fluoropolymers also include copolymers of ethylene and TFE (i.e., “ETFE”). Such polymers may be obtained commercially, for example, as marketed under the trade designations “DYNEON FLUOROTHERMOPLASTIC ET 6210A”, “DYNEON FLUOROTHERMOPLASTIC ET 6235”, or by Dyneon, LLC, or under the trade designation “NEOFLON ETFE” from Daikin America Inc (e.g. NEOFLON ETFE EP521, EP541, EP543, EP610 OR EP620), or under the trade designation “TEFZEL” from E.I. du Pont de Nemours & Company, Wilmington, Del.

Additionally, useful fluoropolymers include copolymers of ethylene and chlorotrifluoroethylene (ECTFE). Commercial examples include Halar 350 and Halar 500 resin from Solvay Solexis Corp.

Other useful fluoropolymers include substantially homopolymers of chlorotrifluoroethylene (PCTFE) such as Aclar from Honeywell.

The term “modified fluoropolymer” is intended to include fluoropolymers that are either bulk modified for surface modified, or both. Bulk fluoropolymer modification includes inclusion of polar functionality that is included or grafted into or onto the fluoropolymer backbone. This type of modified fluoropolymer material can be used in combination with an unmodified fluoropolymer layer and a non fluoropolymer layer or as the base fluoropolymer layer. Suitable functional groups attached in the modified (functionalized) fluoropolymer are carboxylic acid groups such as maleic or succinic anhydride (hydrolyzed to carboxylic acid groups), carbonates, epoxy, acrylate and its derivative such as methacrylate, phosphoric acid and sulfonic acid. Commercially available modified fluoropolymers include Fluon® LM-ETFE AH from Asahi, Neoflon® EFEP RP5000 and Neoflon® ETFE EP7000 from Daikin and Tefzel®HT2202 from DuPont.

Surface modification of fluoropolymers is another way to provide a modified fluoropolymer useful in the present invention. Generally, hydrophilic functionalities are attached to the fluoropolymer surface, rendering it easier to wet and provides opportunities for chemical bonding. There are several methods to functionalize a fluoropolymer surface including chemical etch, physical-mechanical etch, plasma etch, corona treatment, chemical vapor deposition, or any combination thereof. In an embodiment, the chemical etch includes sodium ammonia and sodium naphthalene. An exemplary physical-mechanical etch can include sandblasting and air abrasion with silica. In another embodiment, plasma etching includes reactive plasmas such as hydrogen, oxygen, acetylene, methane, and mixtures thereof with nitrogen, argon, and helium. Corona treatment can include reactive hydrocarbon vapors such as ketones.

Some techniques use a combination of steps including one of these methods. For example, surface activation by plasma or corona in the presence of an excited gas species and optionally cured by E-beam. In another example, the surface can be modified by corona treatment in the presence of a solvent gas such as acetone.

One method to form this multilayer sheet is by extrusion coating of the thermoplastic silicone and a surface modified fluoropolymer. The surface modified fluoropolymer can be obtained from several methods including but not limited to corona treatment of the fluoropolymer in the presence of acetone gas (process described in DuPont U.S. Pat. No. 3,030,290), plasma treatment including plasma enhanced chemical vapor deposition; the plasma deposition could also be followed by E-beam curing (Sigma System).

For treatment, the fluoropolymer resin layers are stripped of any release liner and then exposed to a corona discharge in an organic gas atmosphere, wherein the organic gas atmosphere comprises acetone or an alcohol of four carbon atoms or less. Acetone is the preferred organic gas. The organic gas is admixed with an inert gas and the preferred inert gas is nitrogen. The acetone/nitrogen atmosphere causes an increase of adhesion of the fluoropolymer resin layer to the silicone layer. The fluoropolymer resin layer is stripped of the release liner and then exposed to a corona discharge in an acetone/nitrogen atmosphere to increase adhesion of the fluoropolymer resin layer to the silicone layers.

Corona discharge is produced by capacitative exchange of a gaseous medium which is present between two spaced electrodes, at least one of which is insulated from the gaseous medium by a dielectric barrier. Corona discharge is somewhat limited in origin to alternating currents because of its capacitative nature. It is a high voltage, low current phenomenon with voltages being typically measured in kilovolts and currents being typically measured in milliamperes. Corona discharges may be maintained over wide ranges of pressure and frequency. Pressures of from 0.2 to 10 atmospheres generally define the limits of corona discharge operation and atmospheric pressures generally are preferred. Frequencies ranging from 20 Hz. to 100 MHz. can conveniently be used: in particular ranges are from 500, especially 3000, Hz. to 10 MHz.

When dielectric barriers are employed to insulate each of two spaced electrodes from the gaseous medium, the corona discharge phenomenon is frequently termed an electrodeless discharge, whereas when a single dielectric barrier is employed to insulate only one of the electrodes from the gaseous medium, the resulting corona discharge is frequently termed a semi-corona discharge. The term “corona discharge” is used throughout this specification to denote both types of corona discharge, i.e. both electrodeless discharge and semi-corona discharge.

The effect of exposing the polymeric substrate to the electrical discharge is not fully understood. It appears possible, however, that some form of chemical activation of the surface takes place at the same time as does some attrition of the substrate. The surface activation apparently provides bonding sites for the coating of the condensation polymer but the nature of the bond is fully understood.

All details concerning the corona discharge treatment procedure are provided in a series of U.S. patents assigned to E. I. du Pont de Nemours and Company, USA, described in expired U.S. Pat. Nos. 3,030,290; 3,255,099; 3,274,089; 3,274,090; 3,274,091; 3,275,540; 3,284,331; 3,291,712; 3,296,011; 3,391,314; 3,397,132; 3,485,734; 3,507,763; 3,676,181; 4,549,921 and 6,726,979, the teachings of which are incorporated herein in their entirety for all purposes. An example of the proposed technique may be found in U.S. Pat. No. 3,676,181 (Kowalski). The atmosphere for the enclosed treatment equipment is a 20% acetone (by volume) in nitrogen and is continuous. The constantly fed layer, for example, is subjected to between 0.15 and 2.5 Watt hrs per square foot of the film/sheet surface. The fluoropolymer can be treated on both sides of the film/shape to increase the adhesion. The material can then be placed on a non-siliconized release liner for storage. Materials that are treated in this manner last more than 1 year without significant loss of surface wettability, cementability and adhesion.

In one aspect, the surface of the fluoropolymer substrate is treated with a corona discharge where the electrode area was flooded with acetone, tetrahydrofuran methylethyl ketone, ethyl acetate, isopropyl acetate or propyl acetate vapors. In another aspect, the surface of the fluoropolymer substrate is treated with corona in a nitrogen atmosphere.

In another aspect, the surface of the fluoropolymer substrate is treated with a plasma. The phrase “plasma enhanced chemical vapor deposition” (PECVD) is known in the art and refers to a process that deposits thin films from a gas state (vapor) to a solid state on a substrate. There are some chemical reactions involved in the process which occur after creation of a plasma of the reacting gases. The plasma is generally created by RF (AC) frequency or DC discharge between two electrodes where in between the substrate is placed and the space is filled with the reacting gases. A plasma is any gas in which a significant percentage of the atoms or molecules are ionized, resulting in reactive ions, electrons, radicals and UV radiation.

Ideally the PECVD process is conducted at ambient temperature. However, suitable temperature ranges include from about ambient temperature to about 250° C., in particular from about ambient temperature to about 150° C. and more particularly from about ambient temperature to about 100° C.

Generally the coating is deposited under PECVD conditions at a low pressure.

The process comprises first placing the fluoropolymeric substrate in a vacuum chamber. The pressure of the vacuum chamber is then pumped to a pressure of approximately, 10⁻³ to 10⁻⁵, preferably approximately 10⁻⁴ Torr.

The vacuum chamber contains two conducting electrodes which are placed opposite each other in the chamber. One electrode is connected to an RF power supply and the other electrode is connected to a ground. Alternatively, a DC ion source may be used for ignition of the plasma. The polymeric substrate is placed in contact with the ground electrode.

The vacuum chamber is further connected to a source of gasified liquid that include, acetone, tetrahydrofuran methylethyl ketone, ethyl acetate, isopropyl acetate or propyl acetate or a mixtures thereof. The connections to the gases are typically through mass flow meters. In one configuration, the RF-driven electrode is a shower head electrode, used for the injection of the process gas. The shower head concept leads to a very good uniformity of gas injection on the whole surface.

After a base chamber pressure has been reached, a first gas such as hydrogen can be introduced, followed by a second gas (or combination of gases) into the chamber in a various ratios. It is also possible to use argon, oxygen, ammonia (NH₃), or helium as the pretreatment gas. Mixtures of one or more of these gases are within the scope of the present invention.

The plasma can be ignited by the RF power supply producing about a 40 KHz to about a 2.45 GHz frequency. Alternatively, a DC ion source may be used to ignite the plasma. The power is between about 0.1 to about 1 W/cm², of forward power and the polymeric surface is exposed to the plasma for about 120 seconds, preferably exposure is for approximately 60 seconds. The reaction is conducted at room temperature.

Generally, the substrate can be treated with a plasma that is tetrahydrofuran methylethyl ketone, ethyl acetate, isopropyl acetate, propyl acetate or mixtures thereof.

In another aspect, the surface may be treated with plasma at atmospheric pressure according to the technique of U.S. Pat. No. 6,118,218 (Yializis) using steady-state glow-discharge plasma at atmospheric pressure. The plasma can be ignited by an RF power supply at about 150 kHz. The electrode pair can be a hollow ceramic chamber and a ceramic roll. Gases introduced into the hollow chamber electrode can include hydrogen, helium, argon, nitrogen, oxygen, carbon dioxide, ammonia, acetylene or mixtures thereof. The substrate is generally treated at about 15 to 200 feet per minute, at a supplied power of from about 2 to 10 kW.

Not to be limited by theory, the present novel method has been found to provide strong interlayer adhesion between a modified fluoropolymer and a silicone surface. In one method, a fluoropolymer and a silicone shape are each formed separately.

Fluoropolymers are generally selected as outer layers to provide chemical resistance, electrical insulation, weatherability and/or a barrier to moisture.

It was surprisingly found that thermoplastic silicones are a new class of materials suitable for the encapsulation of photovoltaic cells. The material typically contains at least two parts; a silicone building block having a reactive function at the end of the chain on both sides, and a hard isocyanate block. The reactive functional groups in the silicone backbone are selected from the following groups: amino, hydroxyl, ether oxide, epoxy or thiols. Materials obtained by such a composition are highly transparent and can be processed using conventional thermoplastic equipment such as extrusion.

Preferably the sheets of thermoplastic silicone copolymers are prepared from: a hard segment polymer constituent prepared from an organic monomer or oligomer or combination of organic monomers and/or oligomers such as but not restricted to styrene, methylmethacrylate, butylacrylate, acrylonitrile, alkenyl monomers, isocyanate monomers; and

a soft segment polymer constituent prepared from a compound having at least one silicon atom typically an organopolysiloxane polymer.

Each of the hard and soft segments can be linear or branched polymer networks or combination thereof. Copolymers can be prepared using polymerization of monomers or prepolymers/oligomers.

One type of copolymer for use in the present invention are silicone-urethane and silicone-urea copolymers. Silicone-urethane and silicone-urea copolymers (for example, U.S. Pat. No. 4,840,796, U.S. Pat. No. 4,686,137) have been known to give materials with good mechanical properties such as being elastomeric at room temperature. Desired properties of silicone-urea/urethane copolymers can be obtained by varying the level of polydimethylsiloxane (PDMS), the type of chain extenders used and type of isocyanate used.

The most common way for synthesizing silicone urea or urethane copolymers involves the reaction of silicone functional diamine or diol with excess diisocyanate to form urea or urethane group, respectively. The resulting linear polymer is reacted with short chain diol or diamine as chain extenders.

Among the isocyanates used to synthesize urethane or urea copolymers cyclic aliphatic diisocyanates provide major advantages due to its UV and superior weather resistance.

Suitable silicone-based thermoplastic elastomers include those marketed under the tradename GENIOMER® from Wacker, those described in patent publications WO2007/120197A2 (Drake) and U.S. Pat. No. 6,759,487 (Alphonse), or similar. Suitable silicone materials can also include those capable of being formed as a sheet prior to use in a photovoltaic module, such as materials capable of being partially cured for ease of handling, but still capable of flowing and bonding when exposed to heat and pressure.

Silicone-urethane/urea(s) copolymers are transparent elastomeric material with excellent light transmission. Due to its excellent light transmission and excellent weather resistance these copolymers are useful as encapsulant for the light facing side of photovoltaic cell.

In another aspect, the multi-layer film or laminate can be prepared by use of a tie layer. This includes the formation of a multilayer fluoropolymer film made of a modified fluoropolymer and a non-modified (virgin) fluoropolymer. A preferred method to form the multilayer fluoropolymer film (modified fluoropolymer/non-modified fluoropolymer) is co-extrusion. This composite or laminate can then be further treated with a silicone material to provide a multi-layer film/laminate.

The resultant modified fluoropolymer and silicone shapes are contacted together for example by heat lamination to form a composite laminate.

Fluoropolymeric substrates may be provided in any form (e.g., film, tape, sheet, web, beads, particles, or as a molded or shaped article) as long as fluoropolymer can be melt processed.

The multilayer fluoropolymer film and the thermoplastic. encapsulant could be formed by extrusion coating or heat lamination by a conventional hot roll laminator.

Compared to the state-of-the-art fluoropolymer ETFE/EVA laminate, the formation of a co-processed silicone fluoropolymer sheet allows for a number of advantages, including better weatherability such as sustaining of optical transparency over time, better impact resistance, stronger fluoropolymer/encapsulant adhesion and encapsulant/PV cell interlayer adhesion, reduction of process step in PV cells lamination time, easier handling during production of modules (no need to handle two separate layers).

The present invention provides a process for producing a photovoltaic module comprising an outer coprocessed fluoropolymer thermoplastic silicone layered sheet, an inner photovoltaic active element, and a back protective sheet, wherein the process comprises forming the photovoltaic module in a vacuum sheet laminator or a roll laminator.

The following paragraphs enumerated consecutively from 1 through 9 provide for various aspects of the present invention. In one embodiment, in a first paragraph (1), the present invention provides a multi-layered film comprising a first substrate comprising a modified fluoropolymer having polar functionality; and a second substrate comprising a thermoplastic silicone.

2. The multi-layered film of claim 1, wherein the polar functionality of the first substrate is part of the polymeric backbone of the fluoropolymer.

3. The multi-layered film of claim 1, wherein the polar functionality of the first substrate is from surface modification of the substrate.

4. The multi-layered film of claim 3, wherein the surface modification is by corona discharge, plasma or electron beam discharge.

5. The multi-layered film of claim 4, wherein the corona treatment of the fluoropolymer is conducted in a solvent atmosphere.

6. The multi-layered film of claim 5, wherein the solvent atmosphere is a ketone.

7. The multi-layered film of any of claim 1 or 3 through 6, wherein the first substrate is a copolymer of tetrafluoroethylene.

8. The multi-layered film of claim 7, wherein the copolymer is ETFE, ECTFE, PVDF, PVF, THV, HTE or FEP.

9. The multi-layered film of any of claims 1 through 8, wherein the thermoplastic silicone is a condensation product of a polydimethylsiloxane and a diisocyanate.

The invention will be further described with reference to the following non-limiting Examples. It will be apparent to those skilled in the art that many changes can be made in the embodiments described without departing from the scope of the present invention. Thus the scope of the present invention should not be limited to the embodiments described in this application, but only by embodiments described by the language of the claims and the equivalents of those embodiments. Unless otherwise indicated, all percentages are by weight.

### Examples

A thermoplastic silicone elastomer (GENIOMER from Wacker Chemie) was melt extruded using an extrusion die with L/D of between 25:1 or 30:1. Residence time in the extruder was between about 3 to 7 minutes. Line speed was 10 to 16 fpm. Extruder temperature was approximately 190-195° C. The melted material was cast on to an ETFE film that had previously been surface modified using corona treatment with an acetone containing environment. The silicone/fluoropolymer multilayer construct was then laminated to a piece of amorphous silicon photovoltaic using a Sencorp Model 12-AS/1 heat sealer set to a lamination temperature of 190° C. Lamination times of 8 minutes and 12 minutes were used. Adhesion between the silicone/fluoropolymer multilayer construct and the silicon PV was then measured on an Instron using a T-peel test configuration. Adhesive strength was measured as 87 N/in for 12 minute lamination and 89 N/in for 8 minute lamination. The failure mode was within the multilayer film construction, and indicated a level of adhesion considered acceptable performance at the PV interface.

By way of comparison, a typical adhesion value measured by T-peel for an ETFE/EVA silicon laminate would be greater than about 40 N/in and is considered acceptable.

Although the present invention has been described with reference to preferred embodiments, persons skilled in the art will recognize that changes may be made in form and detail without departing from the spirit and scope of the invention. All references cited throughout the specification, including those in the background, are incorporated herein in their entirety. Those skilled in the art will recognize, or be able to ascertain, using no more than routine experimentation, many equivalents to specific embodiments of the invention described specifically herein. Such equivalents are intended to be encompassed in the scope of the following claims.

What is claimed is:

1. A multi-layered film comprising:
a first substrate comprising a modified fluoropolymer having polar functionality; and
a second substrate comprising a thermoplastic silicone.

2. The multi-layered film of claim 1, wherein the polar functionality of the first substrate is part of the polymeric backbone of the fluoropolymer.

3. The multi-layered film of claim 1, wherein the polar functionality of the first substrate is from surface modification of the substrate.

4. The multi-layered film of claim 1, wherein the first substrate is a copolymer of tetrafluoroethylene, ETFE, ECTFE, PVDF, PVF, THV, HTE or FEP.

5. The multi-layered film of claim 1, wherein the thermoplastic silicone is a condensation product of a polydimethylsiloxane and a diisocyanate.

6. The multi-layered film of claim 3, wherein the first substrate is a copolymer of tetrafluoroethylene, ETFE, ECTFE, PVDF, PVF, THV, HTE or FEP.

7. The multi-layered film of claim 6, wherein the thermoplastic silicone is a condensation product of a polydimethylsiloxane and a diisocyanate.

8. The multi-layered film of claim 3, wherein the surface modification is by corona discharge, plasma or electron beam discharge.

9. The multi-layered film of claim 8, wherein the first substrate is a copolymer of tetrafluoroethylene, ETFE, ECTFE, PVDF, PVF, THV, HTE or FEP.

10. The multi-layered film of claim 9, wherein the thermoplastic silicone is a condensation product of a polydimethylsiloxane and a diisocyanate.

11. The multi-layered film of claim 8, wherein the corona treatment of the fluoropolymer is conducted in a solvent atmosphere.

12. The multi-layered film of claim 11, wherein the first substrate is a copolymer of tetrafluoroethylene, ETFE, ECTFE, PVDF, PVF, THV, HTE or FEP.

13. The multi-layered film of claim 12, wherein the thermoplastic silicone is a condensation product of a polydimethylsiloxane and a diisocyanate.

14. The multi-layered film of claim 11, wherein the solvent atmosphere is a ketone.

15. The multi-layered film of claim 14, wherein the first substrate is a copolymer of tetrafluoroethylene, ETFE, ECTFE, PVDF, PVF, THV, HTE or FEP.

16. The multi-layered film of claim 15, wherein the thermoplastic silicone is a condensation product of a polydimethylsiloxane and a diisocyanate.

17. The multi-layered film of claim 2, wherein the polar functionality of the first substrate is a carboxylic acid, a carbonate, an epoxy, an acrylate, a methacrylate, a phosphoric acid, a sulfonic acid or mixtures thereof.

18. The multi-layered film of claim 17, wherein the first substrate is a copolymer of tetrafluoroethylene, ETFE, ECTFE, PVDF, PVF, THV, HTE or FEP.

19. The multi-layered film of claim 18, wherein the thermoplastic silicone is a condensation product of a polydimethylsiloxane and a diisocyanate.
